(19) United States
(12) Patent Application Publication
(10) Pub. No.: US 2017/0088254 A1
(43) Pub. Date: Mar. 30, 2017

(54) Ultra-High-Pressure Fluid Injection Dynamic Orbit-Transfer System and Method

(71) Applicant: RuiQing Hong, San Gabriel, CA (US)

(72) Inventor: RuiQing Hong, San Gabriel, CA (US)

(21) Appl. No.: 15/201,319

(22) Filed: Jul. 1, 2016

Related U.S. Application Data
(63) Continuation-in-part of application No. 14/004,166, filed on Sep. 10, 2013, now abandoned.

(30) Foreign Application Priority Data
Mar. 10, 2011 (CN) 201110057190.7

(51) Int. Cl. B64C 15/14

(52) U.S. Cl. CPC B64C 15/14

(57) ABSTRACT

A flying object includes a main body, an engine, a power system and an ultra-high-pressure fluid injection dynamic orbit-transfer system which includes a pressure storage device for storing a predetermined amount of ultrahigh-pressure gas, a central automatic control system, at least one air pipeline connected to the pressure storage device, and a nozzle assembly provided on the main body and connected to the air pipeline. The nozzle assembly includes a plurality of nozzle units. Each of the nozzle units includes a nozzle body having a nozzle hole, and is arranged and aligned adjacent to at least another the nozzle unit. The central automatic control system is configured to selectively activate at least two of the nozzle units for ejection of ultrahigh-pressure gas so as to controllably alter a flying locus of the flying object.

### CROSS REFERENCES TO RELATED APPLICATIONS

This is a Continuation-In-Part application of a non-provisional application having an application Ser. No. 14/004,166 and a filing date of Sep. 10, 2013, which is a national phase entry of application number PCT/CN2011/083309 and filing date Dec. 1, 2011. The content of these applications is incorporated by reference herewith.

### BACKGROUND OF THE PRESENT INVENTION

Field of Invention

The present invention relates to aeronautic and astronautic device technology, and more particularly to an ultra-high-pressure fluid injection dynamic orbit-transfer system and method used in a wide variety of flying objects.

Description of Related Arts

Objects in motion, whether they are space shuttles, aviation aircrafts, rockets, missiles flying in the sky, or moving objects sailing on water or moving underwater, will encounter resistance from air or water in the course of the flight or sailing, and will have a need to change its moving directions or paths, which we call “orbit transfer”. The existing orbit-transfer methods mainly rely on mechanical actuation of mechanical parts installed in the flying objects to carrying obit transfer.

The followings are examples of existing technologies for various moving objects:

Space shuttles and aviation aircrafts: the aerodynamic exterior of an aircraft will determine its aerodynamic characteristics under a given air flow state. The exterior of the existing space shuttles, space aircrafts and aviation aircrafts all have their intrinsic design flaws which require installation of a wide variety of auxiliary equipment and devices, and make the overall design of the aircraft become more complicated and difficult to operate. Moreover, the aircrafts, due to the presence of the auxiliary equipment and devices, are heavy in weight therefore low in energy efficiency.

The exterior design of space shuttles has a major aerodynamic flaw. It basically looks like a cigar-shaped metal rod and this kind of aerodynamic shape cannot utilize the force of air to help to improve launching performance. Conventional space shuttles may only utilize a high-thrust rocket for launching. This high-thrust rocket requires the use of enormous amount of energy.

Space aircrafts also imitate the exterior of the space shuttles and its take-off pattern is similar. The difference is that a space aircraft uses a larger aircraft to launch and separates itself from this aircraft when it is in the sky. After that, the space aircraft opens its carry-on rocket engines to fly out of the atmospheric layer. Therefore, the shortcomings of the space shuttles are fully inherited to space aircrafts.

The take-off of a plane mainly relies on the acting force produced by the two wings and the air. Due to the much-limited contact area between an aircraft's wing and the air, the only way to speed up the take-off speed of an aircraft to compensate insufficient launching force of the aircraft is to increase engine's power.

An aircraft mainly fly in straight-line motions and the process of taking-off, landing and transferring orbits have to be finished in a very short amount of time.

Furthermore, since all the mechanical structures of an aircraft or flying objects are very complicated, they may to undesirably interfere with each other. This increases the chance that any one of the mechanical components is damaged by the others. Moreover, the more complex a mechanical structure is, the more difficult for it to be controlled, and the lower the safety performance of an aircraft will have.

As a result, there is a need to develop an orbit-transfer system which may assist a flying object such as an aircraft to perform orbit transfer effectively and efficiently.

### SUMMARY OF THE PRESENT INVENTION

Certain variations of the present invention provide an ultra-high-pressure fluid injection dynamic orbit-transfer system and method used in a wide variety of flying objects.

Certain variations of the present invention provide an ultra-high-pressure fluid injection dynamic orbit-transfer system and method, which may assist a flying object, such as an aircraft, to carry out orbit transfer effectively and efficiently.

Certain variations of the present invention provide an ultra-high-pressure fluid injection dynamic orbit-transfer system, wherein ultra-high pressure fluid is ejected out of a nozzle assembly so as to alter a flying path of the flying object on which the present invention is installed.

Certain variations of the present invention provide an ultra-high-pressure fluid injection dynamic orbit-transfer system which comprise a nozzle assembly and at least one ejection spout provided on various locations of the flying object for ejecting ultra-high fluid pressure for altering a flying path or velocity of the flying object.

Certain variations of the present invention provide an ultra-high-pressure fluid injection dynamic orbit-transfer system which comprise a nozzle assembly constructed to form a honeycomb structure.

Certain variations of the present invention provide an ultra-high-pressure fluid injection dynamic orbit-transfer system which is capable of minimizing the number of physical apparatuses used in accomplishing changing flying direction or flying velocity of the flying object.

Certain variations of the present invention provide a flying object, comprising:

a main body;

an engine supported in the main body for providing driving force for the main body to fly above the ground;

a power system supported in the main body for providing power to drive the engine; and

an ultra-high-pressure fluid injection dynamic orbit-transfer system, which comprises:

a pressure storage device supported in the flying object and connected to the engine and arranged to store a predetermined amount of ultra-high-pressure gas;

a central automatic control system supported in the aircraft;

at least one air pipeline connected to the storage device; and

a nozzle assembly provided on the main body and connected to the air pipeline, the nozzle assembly comprising a plurality of nozzle units, each of the nozzle units having a nozzle hole and being arranged and aligned adjacent to at least another the nozzle unit to form a honeycomb geometry alignment pattern of the nozzle units, the central automatic control system being configured to selectively activate at least two of the nozzle units for ejection of ultrahigh-pressure gas so as to controllably alter a flying locus of the flying object.

### BRIEF DESCRIPTION OF THE DRAWINGS

FIG. 1 is a schematic diagram of a flying object according to a preferred embodiment of the present invention, illustrating that the flying object is configured as an airplane.

FIG. 2 is a system block diagram of an ultra-high-pressure fluid injection dynamic orbit-transfer system according to a preferred embodiment of the present invention.

FIG. 3 is a perspective view of a nozzle assembly of the ultra-high-pressure fluid injection dynamic orbit-transfer system according to the preferred embodiment of the present invention.

FIG. 4A is a perspective view of a nozzle unit of the ultra-high-pressure fluid injection dynamic orbit-transfer system according to the preferred embodiment of the present invention.

FIG. 4B is a perspective view of a nozzle unit of the ultra-high-pressure fluid injection dynamic orbit-transfer system according to the preferred embodiment of the present invention, illustrating that the nozzle unit is rotated through a predetermined angle.

FIG. 5A to FIG. 5C are schematic diagrams of a nozzle assembly of the ultra-high-pressure fluid injection dynamic orbit-transfer system according to the preferred embodiment of the present invention, illustrating three particular ejection patterns of the nozzle assembly respectively.

FIG. 6 is a schematic side view of a wing portion of the flying object according to the preferred embodiment of the present invention, illustrating that the ultra-high pressure gas may form a gas barrier to the airflow passing through the flying object.

FIG. 7 is a schematic diagram of a flying object comprising the ultra-high-pressure fluid injection dynamic orbit-transfer system according to a first alternative mode of the preferred embodiment of the present invention.

FIG. 8 is a schematic diagram of an ultra-high-pressure fluid injection dynamic orbit-transfer system installed in a flying object according to a second alternative mode of the preferred embodiment of the present invention.

### DETAILED DESCRIPTION OF THE PREFERRED EMBODIMENT

The following detailed description of the preferred embodiment is the preferred mode of carrying out the invention. The description is not to be taken in any limiting sense. It is presented for the purpose of illustrating the general principles of the present invention.

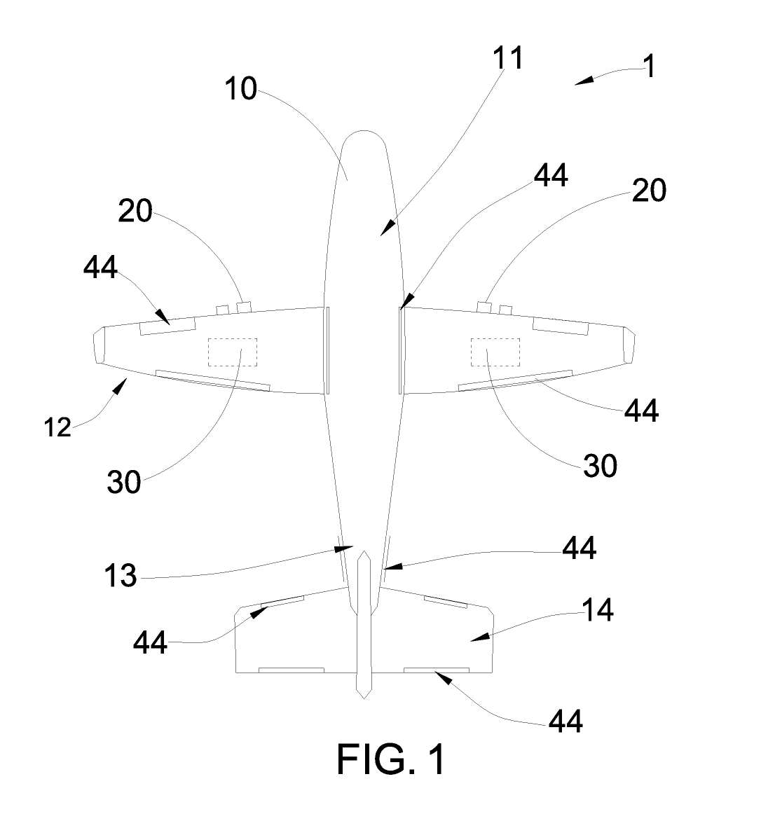

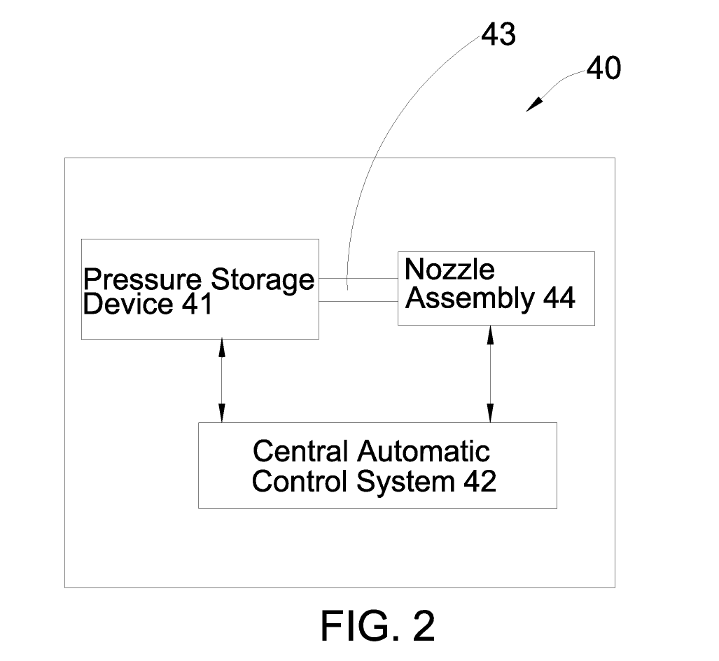

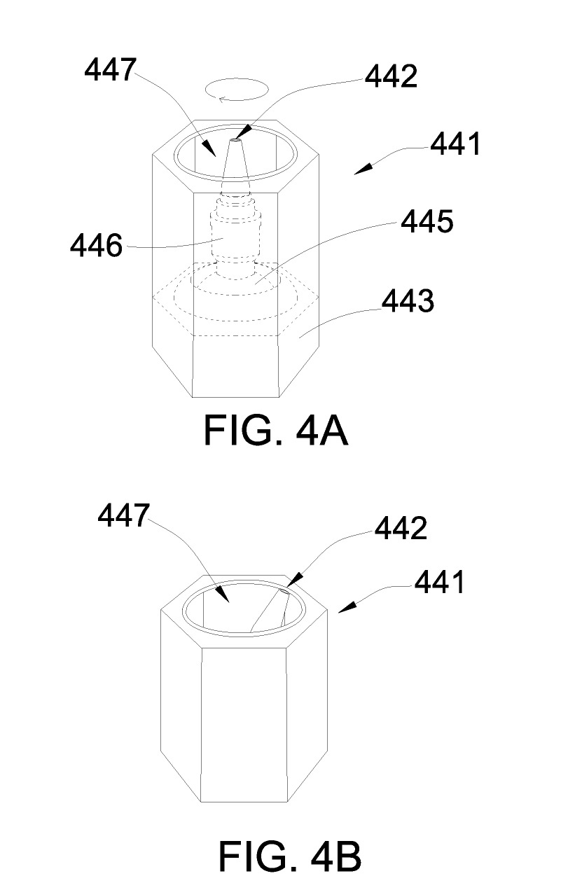

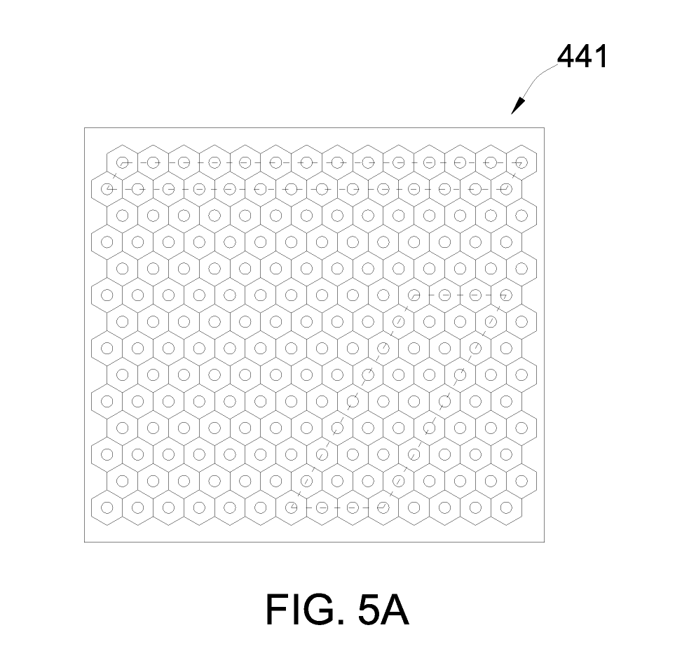

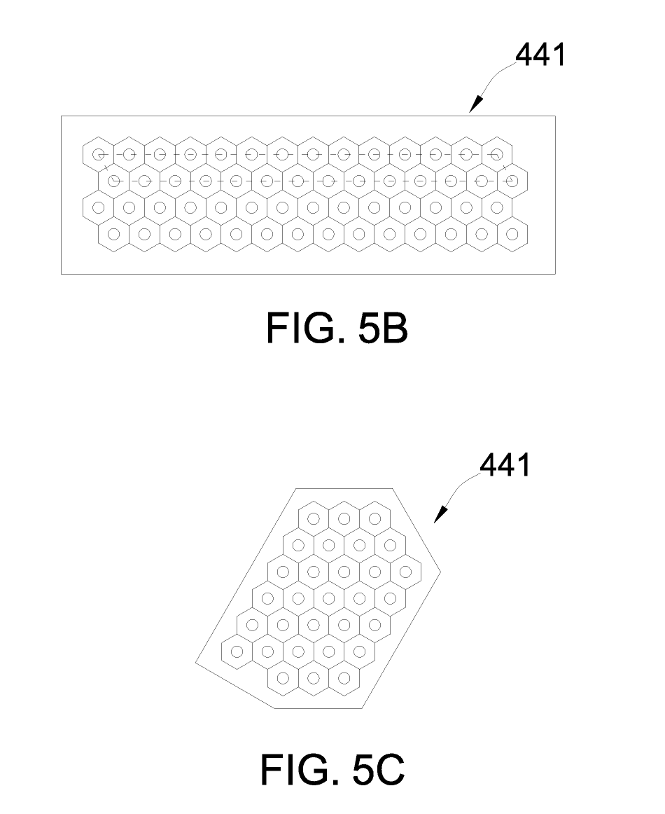

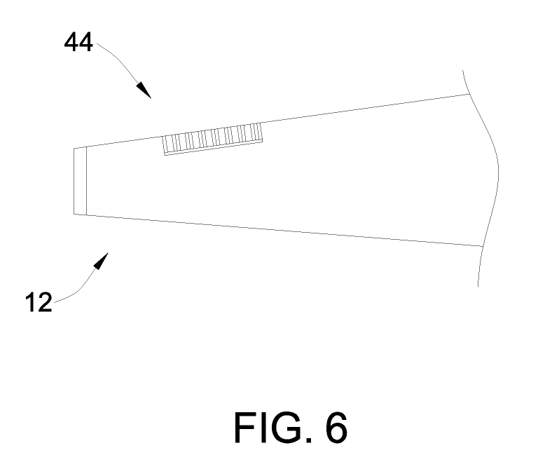

Referring to FIG. 1 to FIG. 3, FIG. 4A to FIG. 4B, FIG. 5A to FIG. 5C and FIG. 6 of the drawings, a flying object 1 according to a preferred embodiment of the present invention is illustrated. The flying object 1, such as an aircraft, may comprise a main body 10, an engine 20, a power system 30, and an ultra-high-pressure fluid injection dynamic orbit-transfer system 40.

The engine 20 may be supported in the main body 10 for providing a driving force for the main body to fly in the air or to move under water. The power system 30 may be supported in the main body 10 for providing power to the engine 20 and other components of the flying object 1.

The ultra-high-pressure fluid injection dynamic orbit-transfer system 40 may comprise a pressure storage device 41, a central automatic control system 42, a plurality of air pipelines 43 and a nozzle assembly 44.

The pressure storage device 41 may be supported in the main body 10 of the flying object 1 and arranged to store a predetermined amount of ultra-high-pressure gas. The central automatic control system 42 may be supported in the main body 10 of the flying object 1. The air pipelines 43 may be connected to the pressure storage device 41 and the nozzle assembly 44.

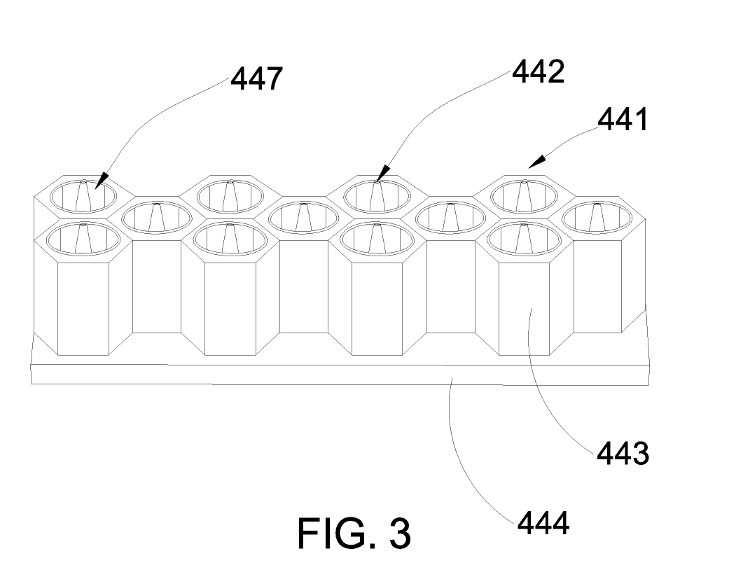

The nozzle assembly 44 may be provided on the main body, and connected to the air pipeline 43. The nozzle assembly 44 may comprise a plurality of nozzle units 441, wherein each of the nozzle units 441 may have a nozzle hole 442, and may be arranged and aligned adjacent to at least another nozzle unit 441 so as to form a honeycomb geometry alignment pattern of the nozzle units 441, as shown in FIG. 3 and FIG. 4A to FIG. 4B, FIG. 5A to FIG. 5C and FIG. 6 of the drawings. The central automatic control system 42 may be programmed and configured to selectively activate at least two of the nozzle units 441 for ejection of ultrahigh-pressure gas so as to controllably alter a flying locus of the flying object 1.

According to the preferred embodiment of the present invention, the flying object 1 may be configured as a wide variety of objects which may fly in the air or move under water. In other words, the flying object 1 may be an object which may move in a fluid. Examples of the flying object 1 may include an airplane, a military aircraft, a rocket, a missile, or a flying saucer. Moreover, the flying object 1 of the present invention may be self-propelled or launched to fly by other devices. In the preferred embodiment, the flying object 1 may be configured as an airplane. As shown in FIG. 1 of the drawings, the main body 10 may be configured to have an elongated central portion 11, two wing portions 12 transversely extended from two sides of the elongated central portion 11, a tail portion 13, and a tail wing portion 14. Since the flying object 1 in this preferred embodiment is configured as an airplane, the two engines 20 may be provided on two wing portions 12 of the main body 10.

The power system 30 may be provided in the main body 10 and connected to the engine 20. The power system 30 may be configured to store fuel and accomplish controlled combustion of the fuel so as to allow the engine 20 to produce enough thrust for driving the entire flying object 1 to move in the air. A cooling system may also be installed in the main body for cooling the engine 20. The engine 20 may be configured as a gas turbine used as a jet engine. Moreover, the power system 30 may also generate electrical power for use by electrical components installed in the flying object 1. The power system 30 may be controlled by the central automatic control system 42.

The pressure storage device 41 of the ultra-high-pressure fluid injection dynamic orbit-transfer system 40 may be arranged to store a predetermined amount of ultra-high pressure gas. The ultra-high-pressure gas may be ejected by the nozzle assembly 44 (described below). The pressure ejected from the pressure storage device 41 may be equal to or greater than 100K Pa. This range is the preferred pressure range for ultra-high pressure for altering a flying path of the flying object 1.

The central automatic control system 42 may be provided in the main body 10 of the flying object 1, and may be configured to control an opening or closing of any number of the nozzle units 441 so as to produce the a predetermined ejection pattern of the ultra-high-pressure fluid injection dynamic orbit-transfer system 40 (described below in more detail). The central automatic control system 42 may also be configured to control the operation and flying parameters of the flying object 1.

The air pipelines 43 may be configured to withstand high pressure and high temperature so that the air pipelines 43 may be utilized for transporting the ultra-high pressure gas from the pressure storage device 41 to the nozzle assembly 44.

The nozzle assembly 44 may comprise the nozzle units 441 as described above. The flying object 1 may comprise a plurality of nozzle assemblies 44, wherein each of the nozzle assemblies 44 is provided at a predetermined location on the flying object so as to alter an aerodynamic properties of the flying object 1. For example, as shown in FIG. 1 of the drawings, two nozzle assemblies 44 may be provided on a front edge and a rear edge of a wing portion 12 of the flying object 1 respectively. Each of the nozzle assemblies 44 may eject ultra-high pressure gas at a predetermined direction to alter aerodynamic properties of the flying object 1. As shown in FIG. 1 of the drawings, the nozzle assemblies 44 may be provided on the wing portions 12, and the elongated central portion 11 of the flying object 1 which is configured as an airplane. Specifically, the nozzle assemblies 44 may be formed on a front edge and a rear edge of each of the wing portions 12, two sides of the tail portion 13, the tail wing portion 14, and two side surfaces of the elongated central portion 11 of the main body 10. It is worth mentioning that the number of nozzles assemblies 44 and their positions on the flying object 1 may be varied for achieving different aerodynamic properties by the flying object 1.

Referring to FIG. 3 and FIG. 4A to FIG. 4B of the drawings, each of the nozzle assemblies 44 may comprise a plurality of nozzle units 441 in which each of the nozzle units 441 may comprise a nozzle body 443 and a nozzle head 446 wherein the corresponding nozzle hole 442 is formed on the nozzle head 446 for ejecting ultra-high pressure gas. Each of the nozzle bodies 443 may have a receiving slot 447 for receiving the nozzle head 446. For each of the nozzle assemblies 44, the nozzle units 441 may be arranged in a predetermined number of rows and columns so as to form an array. Moreover, each of the nozzle bodies 443 may be attached to at least one of an adjacent nozzle bodies 443 in a side-by-side manner for forming an integral structure of the corresponding nozzle assembly 44. As shown in FIG. 5A of the drawings, an exemplary nozzle assembly 44 is illustrated in which the nozzle units 441 may be arranged in a square array of fourteen rows and fourteen columns. Each of the nozzle units 441 may be selectively activated by the central automatic control system 42 for ejecting ultra-high pressure gas. When the topmost twenty eight nozzles units 441 are activated, the ultra-high pressure gas ejected from these nozzle units 441 may form a substantially rectangular geometrical ejection pattern for accomplishing a predetermined aerodynamic property for the flying object 1. Similarly, when the activated nozzle units 441 are in a parallelogram arrangement, the ultra-high pressure gas ejected from these nozzle units 441 may form a corresponding parallelogram geometrical pattern.

It is worth mentioning that each of the nozzle bodies 443 may have a cross sectional shape other than that shown in the drawings. For example, each of the nozzle bodies 443 may have a hexagonal cross sectional shape, a rectangular cross sectional shape, a circular cross sectional shape, or other cross sectional shapes.

An alternative configuration of the nozzle units 441 may be illustrated in FIG. 5B of the drawings, in which the nozzle units 441 may be arranged in 14 columns and 4 rows. In this example, the nozzle assembly 44 may comprise fifty six nozzle units 441 arranged in a rectangular array having four rows and fourteen columns. When the bottommost twenty eight nozzle units 441 are activated, the ultra-high pressure gas ejected from these nozzle units 441 may also form a substantially rectangular geometrical pattern.

In order to form a honeycomb structure of the nozzle assembly 44, when more than one row and one column of the nozzle units 441 are present, each of the nozzle units 441 may be arranged such that a nozzle unit 441 in a particular row is placed at a position between two nozzle units 441 which are at the adjacently upper or lower row. Such a configuration is shown in FIG. 4A to FIG. 4B and FIG. 5A to FIG. 5C of the drawings.

Each of the nozzle bodies 443 may be configured as having a predetermined cross sectional shape for forming the honeycomb structure of the corresponding nozzle assembly 44. For example, as shown in FIG. 4A to FIG. 4B and FIG. 5A to FIG. 5C of the drawings, each of the nozzle bodies 443 may have a hexagonal cross sectional shape. Other cross sectional shapes of the nozzle bodies 443 are possible, such as a rectangular cross sectional shape, a circular cross sectional shape, or even a triangular cross sectional shape.

Note that the number of nozzle units 441 activated for a given nozzle assembly 44 may be controlled and varied by the central automatic control system 42, which may be programmed to manage and monitor the overall flying path and the corresponding flying parameters of the flying object 1.

Each of the nozzle assemblies 44 may further comprise a supporting frame 444 connecting all of the corresponding nozzle units 441 so as to support the nozzle units 441 in the honeycomb configuration. The supporting frame 444 along with the nozzle units 441 may then be installed on the flying object 1. A cross sectional shape of the supporting frame 444 may also be varied according to the circumstances in which the present invention is to be used. FIG. 5A to FIG. 5C illustrate different cross sectional shapes of the supporting frame 444.

As shown in FIG. 4A to FIG. 4B of the drawings, each of the nozzle units 441 may further comprise a ball joint 445 connecting the corresponding nozzle body 443 to the supporting frame 444 so as to allow each of the nozzle units 441 to controllably rotate with respect to the supporting frame 444. As such, the direction of ejection of the ultra-high pressure gas may be adjusted and controlled by controllably rotating the nozzle units 441 through ball joints 445.

As shown in FIG. 6 of the drawings, when the nozzle assembly 44 is installed on the wing portion 12 of the elongated main body 11, and is arranged to eject ultra-high pressure gas at a direction which is perpendicular to that of the air flowing pass the flying object 1, the ultra-high pressure gas may form a gas barrier to the air flowing pass the flying object 1. This gas barrier may alter the direction of the air flowing through the flying object 1 and may therefore cause the flying object 1 to change its flying direction.

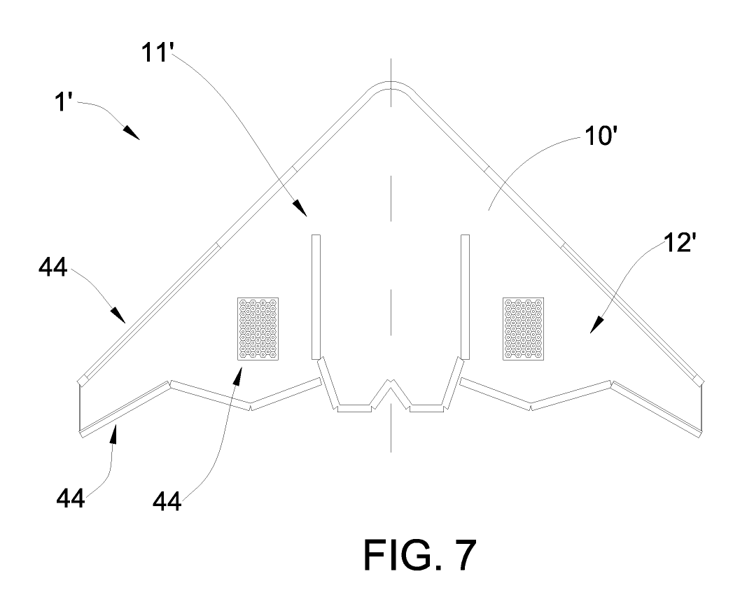

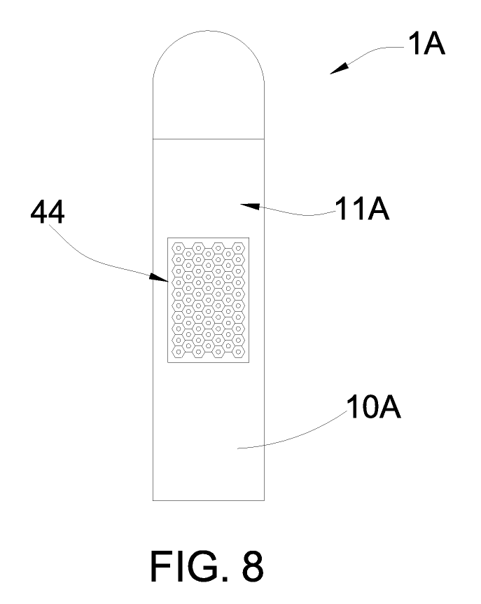

Referring to FIG. 7 of the drawings, an alternative mode of the flying object 1′ according to the preferred embodiment of the present invention is illustrated. The flying object 1′ in the alternative mode is similar to that of the preferred embodiment described above, except the main body 10′. In this first alternative mode, the flying object 1′ may be configured as a military aircraft so that the external contour of the main body 10′ is different from that described in the preferred embodiment. As shown in FIG. 8 of the drawings, the main body 10′ does not have the tail portion 13. The nozzle assemblies 44 may be provided on a front edge and a rear edge of each of the wing portions 12′, and on the central body 11′. The nozzle assemblies 44 may then eject ultra-high pressure at different directions so as to alter horizontal air flow passing through the flying object 1′ when the flying object 1′ is flying in the air. When the air flowing through the flying object 1′ is altered, the direction or velocity of the flying object 1′ may be altered accordingly.

Referring to FIG. 8 of the drawings, a flying object 1A according to a second alternative mode of the present invention is illustrated. The flying object 1A is similar to the preferred embodiment, except that the main body 10A may be configured as having only an elongated central portion 11A. The nozzle assemblies 44 may be provided on two sides of the main body 10A for ejecting ultra-high pressure gas. The main body 10A of the flying object in this second alternative mode may be adopted as a main body of a rocket or a missile.

The present invention, while illustrated and described in terms of a preferred embodiment and several alternatives, is not limited to the particular description contained in this specification. Additional alternative or equivalent components could also be used to practice the present invention.

What is claimed is:

1. A flying object, comprising:
a main body;
an engine supported in said main body for providing a driving force for said main body to fly in air;
a power system supported in said main body and connected to said engine; and
an ultra-high-pressure fluid injection dynamic orbit-transfer system, which comprises:
a pressure storage device supported in said main body and connected to said engine, and arranged to store a predetermined amount of ultrahigh-pressure gas;
a central automatic control system supported in said main body;
at least one air pipeline connected to said storage device; and
a nozzle assembly provided on said main body and connected to said air pipeline, said nozzle assembly comprising a plurality of nozzle units, each of said nozzle units comprising a nozzle body having a nozzle hole, and being arranged and aligned adjacent to at least another said nozzle unit, said central automatic control system being configured to selectively activate at least two of said nozzle units for ejection of ultrahigh-pressure gas so as to controllably alter a flying locus of said flying object.

2. The flying object, as recited in claim 1, further comprising a plurality of nozzle assemblies provided on said main body, each of said nozzle assemblies comprising a supporting frame, a plurality of nozzle units, each of said nozzle units being connected to at least one adjacent nozzle unit and having nozzle head and a nozzle hole formed thereon, said central automatic control system being configured to selectively activate at least two of said nozzle units for ejection of ultrahigh-pressure gas so as to controllably alter a flying locus of said flying object.

3. The flying object, as recited in claim 2, wherein said nozzle units of each of said nozzle assemblies are arranged in an array having at least two rows and two columns.

4. The flying object, as recited in claim 3, wherein each nozzle unit in said second row of each of said nozzle assemblies is arranged such that said nozzle unit is placed at a position between said two nozzle units which are at said adjacently upper and lower row to form a honeycomb structure of said corresponding nozzle assembly.

5. The flying object, as recited in claim 4, wherein each of said nozzle units is rotatably mounted on said supporting frame so as to eject said ultra-high pressure gas at a predetermined orientation.

6. The flying object, as recited in claim 2, wherein said main body has an elongated central portion, two wing portions transversely extended from two sides of said elongated central portion, and a tail portion to form an airplane contour, wherein said nozzle assemblies are provided on at least one of said elongated central portion, two wing portions and a tail portion of said main body.

7. The flying object, as recited in claim 4, wherein said main body has an elongated central portion, two wing portions transversely extended from two sides of said elongated central portion, and a tail portion to form an airplane contour, wherein said nozzle assemblies are provided on at least one of said elongated central portion, two wing portions and a tail portion of said main body.

8. The flying object, as recited in claim 5, wherein said main body has an elongated central portion, two wing portions transversely extended from two sides of said elongated central portion, and a tail portion to form an airplane contour, wherein said nozzle assemblies are provided on at least one of said elongated central portion, two wing portions and a tail portion of said main body.

9. The flying object, as recited in claim 6, wherein at least four of said nozzle assemblies are provided on a front edge and a rear edge of each of said wing portions of said main body respectively.

10. The flying object, as recited in claim 7, wherein at least four of said nozzle assemblies are provided on a front edge and a rear edge of each of said wing portions of said main body respectively.

11. The flying object, as recited in claim 8, wherein at least four of said nozzle assemblies are provided on a front edge and a rear edge of each of said wing portions of said main body respectively.

12. The flying object, as recited in claim 9, wherein at least two of said nozzle assemblies are provided on two sides of said elongated central portion of said main body.

13. The flying object, as recited in claim 10, wherein at least two of said nozzle assemblies are provided on two sides of said elongated central portion of said main body.

14. The flying object, as recited in claim 11, wherein at least two of said nozzle assemblies are provided on two sides of said elongated central portion of said main body.

15. The flying object, as recited in claim 2, being configured as a rocket in such a manner that said main body has an elongated central portion, wherein at least two of said nozzle assemblies are provided on two sides of said main body for ejecting ultra-high pressure gas.

16. The flying object, as recited in claim 4, being configured as a rocket in such a manner that said main body has an elongated central portion, wherein at least two of said nozzle assemblies are provided on two sides of said main body for ejecting ultra-high pressure gas.

17. The flying object, as recited in claim 5, being configured as a rocket in such a manner that said main body has an elongated central portion, wherein at least two of said nozzle assemblies are provided on two sides of said main body for ejecting ultra-high pressure gas.
